(19) United States
(12) Patent Application Publication
(10) Pub. No.: US 2024/0005698 A1
(43) Pub. Date: Jan. 4, 2024

(54) ACCURATE HEAD POSE AND EYE GAZE SIGNAL ANALYSIS

(71) Applicant: Microsoft Technology Licensing, LLC, Redmond, WA (US)

(72) Inventors: Jonathan Michael THIER, Seattle, WA (US); Alexandros NEOPHYTOU, London (GB); Eric CW SOMMERLADE, Oxford (GB)

(73) Assignee: Microsoft Technology Licensing, LLC, Redmond, WA (US)

(21) Appl. No.: 17/852,753

(22) Filed: Jun. 29, 2022

(51) Int. Cl. G06V 40/16; G06V 10/82; G06F 3/01

(52) U.S. Cl. CPC G06V 40/169; G06F 3/013; G06V 10/82; G06V 40/166

(57) ABSTRACT

Aspects of the present disclosure relate to systems and methods for generating a predicted eye gaze of a user and or a predicted head pose of a user. In examples, feature information for a first eye of a user is generated based on a first image and a second image, where the first image is received from a first image sensor and the second image is received from a second image sensor. Feature information for a second eye of the user and facial landmark features are generated based on the first image and the second image. A predicted eye gaze for the user and/or a predicted head pose for the user may be based on the extracted feature information for the first eye, the second eye, and the extracted facial landmark features, and a confidence level for the predictions can be based on a hinge angle between the image sensors.

### BACKGROUND

Gaze prediction and tracking allows the use of a person's eyes to manipulate input on a device, such as a mobile computing device. Many devices utilize one or more applications to predict a person's eye gaze. While many devices may utilize multiple image sensors, such as one or more cameras integrated into each display or screen of such device, to achieve an increased accuracy when predicting and/or tracking the gaze of the user, there remains room for improvement to increase eye gaze prediction accuracy, and in some instances, head pose prediction accuracy. It is with respect to these and other general considerations that embodiments have been described. Also, although relatively specific problems have been discussed, it should be understood that the embodiments should not be limited to solving the specific problems identified in the background.

### SUMMARY

Aspects of the present disclosure are directed to predicting eye gaze information of a user and/or predicting head pose information of a user and then using the predicted eye gaze and/or predicted head pose to control one or more functions associated with a computing device or system.

In accordance with at least one aspect of the present disclosure, a method for generating a predicted eye gaze of a user is disclosed. The method may include receiving a first image of a user from a first camera; receiving a second image of the user from a second camera; obtaining a hinge angle between the first camera and the second camera; extracting feature information for a first eye of the user based on the first image and the second image; extracting feature information for a second eye of the user based on the first image and the second image; extracting facial landmark features for the user based on at least one of the first image and the second image; and generating, using an eye gaze predictor, a predicted eye gaze for the user based on the extracted feature information for the first eye of the user, the extracted feature information for the second eye of the user, and the extracted facial landmark features, wherein a confidence level associated with the predicted eye gaze for the user is based on the obtained hinge angle.

In accordance with at least one aspect of the present disclosure, a system for generating at least one of a predicted eye gaze or a predicted head pose of a user, is described. The system may include a processor; a first image sensor; a second image sensor; and memory including instructions, which when executed by the processor, cause the processor to: receive a first image of a user from the first image sensor; receive a second image of the user from the second image sensor; obtain a hinge angle between a first display associated with the first image sensor and a second display associated with the second image sensor; extract feature information for a first eye of the user based on the first image and the second image; extract feature information for a second eye of the user based on the first image and the second image; extract facial landmark features for the user based on at least one of the first image and the second image; generate an estimated eye gaze for the user based on the extracted feature information for the first eye of the user, the extracted feature information for the second eye of the user, and the extracted facial landmark features; calculate a first angle of offset between an optical axis of the first image sensor and a visual axis of the user; calculate a second angle of offset between an optical axis of the second image sensor and the visual axis of the user; and generate at least one of a predicted eye gaze for the user or a predicted head pose for the user based on extracted feature information for the first eye of the user, extracted feature information for the second eye of the user, extracted facial landmark features, and at least one of the first and second angle of offsets.

In accordance with at least one aspect of the present disclosure, a computer storage medium is described. The computer storage medium may include instructions, which when executed by a processor, cause the processor to: receive a first image of a user from a first image sensor; receive a second image of the user from a second image sensor; obtain a hinge angle between a first display associated with the first image sensor and a second display associated with the second image sensor; extract feature information for a first eye of the user based on the first image and the second image; extract feature information for a second eye of the user based on the first image and the second image; extract facial landmark features for the user based on at least one of the first image and the second image; and generate at least one of a predicted eye gaze for the user or a predicted head pose for the user based on the extracted feature information for the first eye of the user, the extracted feature information for the second eye of the user, and the extracted facial landmark features, wherein the at least one of the predicted eye gaze for the user or the predicted head pose for the user is based on an angle of offset between an optical axis of an image sensor and a visual axis of the user.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts an eye gaze tracking system and/or head pose tracking system in accordance with examples of the present disclosure.

FIG. 2 depicts example display configurations that may be utilized during an enrollment process and or encountered during use of a dual screen mobile computing device.

FIG. 3 depicts an example of a block diagram for obtaining a predicted eye gaze and/or predicted head pose of a user in accordance with examples of the present disclosure.

FIG. 4 depicts a block diagram illustrating physical components (e.g., hardware) of a computing device with which aspects of the disclosure may be practiced.

FIGS. 5A-5B illustrate a mobile computing device with which examples of the disclosure may be practiced.

FIG. 6 depicts details of a method for obtaining calibration information at different hinge angles for the generation of eye gaze prediction information and/or head pose prediction information in accordance with examples of the present disclosure.

FIG. 7 depicts details of a method for generating an eye gaze prediction and/or a head pose prediction utilizing a hinge angle between displays of a dual screen computing device in accordance with examples of the present disclosure.

FIG. 8 depicts details of a method for obtaining a hinge angle between one or more displays of a dual screen computing device in accordance with examples of the present disclosure.

FIG. 9 depicts an example of a display configuration in accordance with examples of the present disclosure.

FIG. 10 illustrates an aspect of the architecture of a system for processing data received at a computing system from a remote source in accordance with examples of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems, or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Aspects of the present disclosure are directed to predicting eye gaze information of a user and/or predicting head pose information of a user and then using the predicted eye gaze and/or predicted head pose to control one or more functions associated with a computing device or system. As the productivity and usability of mobile computing devices, such as but not limited to smartphones, increases, one potential limitation of such devices is related to the display size. Thus, mobile computing devices may include two or more displays thereby allowing a user to view additional information utilizing a larger composite display comprised of two or more smaller displays. In examples, two or more displays may be connected or otherwise coupled to one another utilizing a hinge or other coupling means. As previously mentioned, each of the displays may include an image sensor, such as a camera, to acquire one or more images of the user and/or a video stream comprising one or more images of the user. Such images may be utilized to predict an eye gaze of the user and/or a head pose of the user. For example, while capturing simultaneous input streams from different image sensors, such streams may be provided to one or more trained neural networks, which may generate a more accurate, predicted eye gaze and or predicted head pose for the user, where the user is located within the field of view of the image sensors. In examples, the predicted eye gaze and or predicted head pose may be tracked and may be used to control one or more functions associated with the computing device and/or may be implemented in a synthetically generated image of a user.

In accordance with examples of the present disclosure, a user may initially proceed through an enrollment processes, utilizing an image sensor configuration, where the image sensor configuration may include two or more image sensors. In some examples, each image sensor may be implemented as part of a display or otherwise associated with a display. In some examples, a hinge angle between each image sensor, or each display associated with the image sensor, may be known or otherwise generated and provided as an input to the trained neural network model, where such hinge angle may be utilized to increase an accuracy of a predicted eye gaze and/or predicted head pose of a user. In examples, during the enrollment process, one or more calibration targets may appear on a display whereby the predicted eye gaze and/or predicted head pose may be based on the location of the calibration target and the hinge angle between the two display devices. Of course, such implementations are not limited to two image sensors, but may include more than two image sensors. Utilizing more than two image sensors may improve the accuracy of the predicted eye gaze and/or predicted head pose during the enrollment process, allowing a user's eye location to be determined more accurately utilizing triangulation. Further, having multiple views of a user's eyes based on respective varying hinge angles may provide more accurate three-dimensional reconstruction of a user's eye when used in synthetic generated applications and models such as an avatar. In some examples, the hinge angle between each of the image sensors (or each display associated with a respective image sensor), whether received from a hinge sensor or calculated, may be used to provide a confidence level of a predicted eye gaze of a user and/or a predicted head pose of a user within a certain confidence level.

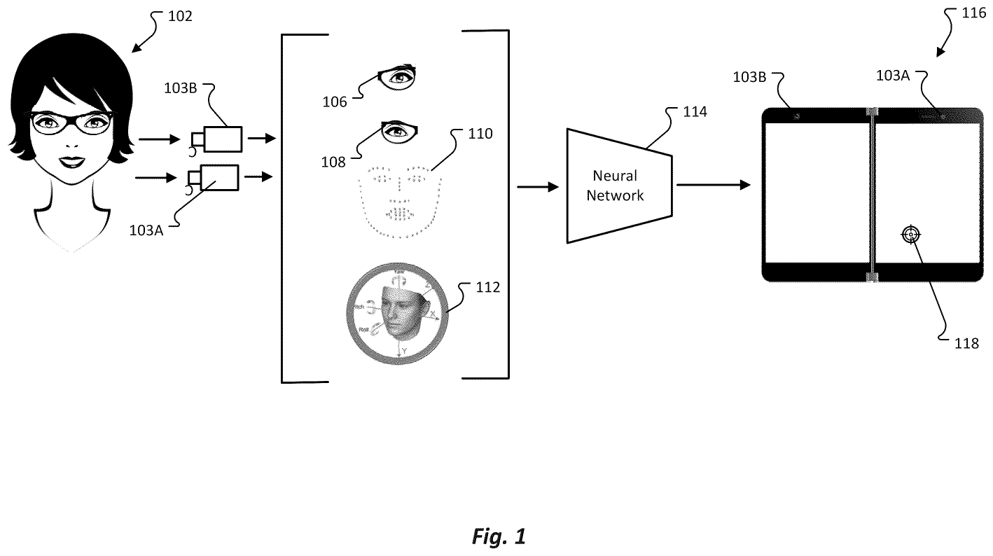

FIG. 1 depicts an eye gaze tracking system and/or head pose tracking system 100 in accordance with examples of the present disclosure. The eye gaze tracking system and/or head pose tracking system 100 may acquire an image of a face belonging to a user 102, for example, utilizing two or more image sensors, or cameras 103A and 103B. That is, an image from each of the cameras 103A and 103B may include a face of the user 102 such that facial landmarks 110, the right eye 106, and the left eye 108 may be identified and/or localized. In some examples, rotational characteristics 112 (e.g., angle of rotation around x, y, and z axes) may also be obtained. The image of the right eye 106, image of the left eye 108, facial landmarks 110, and/or rotational characteristics 112, may be provided to a neural network model 114 specifically trained to predict eye gaze and/or head pose of a user, such as the user 102. That is, the neural network may receive as input one or more set of landmarks, eye images and head pose set for each of the image sensors. As one non-limiting example, a dual screen mobile computing device, such as a dual screen device mobile computing device 116 having a first display with a first camera or image sensor 103A and a second display with a second camera or image sensor 103B, may be utilized with the neural network model 114 to generate a predicted eye gaze and/or predicted head pose of a user.

As previously discussed, the predicted eye gaze and/or predicted head pose of a user 102 may be determined based on a previously performed enrollment process conducted by a user, such as user 102. In examples, the one or more targets 118 may be displayed on one or more displays of the dual screen mobile computing device 116 and a hinge angle obtained from a hinge sensor or otherwise calculated may be obtained at a same time. That is, in some examples, the hinge angle may be utilized by the neural network model 114 to generate an eye gaze prediction and/or head pose prediction having an increased accuracy. Alternatively, or in addition, the hinge angle may be utilized to identify one or more calibration parameters that are based on the hinge angle; such calibration parameters may be utilized by the neural network model 114 to generate an eye gaze prediction and/or head pose prediction having an increased accuracy. Alternatively, or in addition, the hinge angle may be utilized to provide a confidence level associated with a predicted eye gaze and/or predicted head pose of a user; that is, using the hinge angle, a predicted eye gaze and/or a predicted head pose may be associated with a confidence level based on one or more hinge angles obtained during an enrollment process.

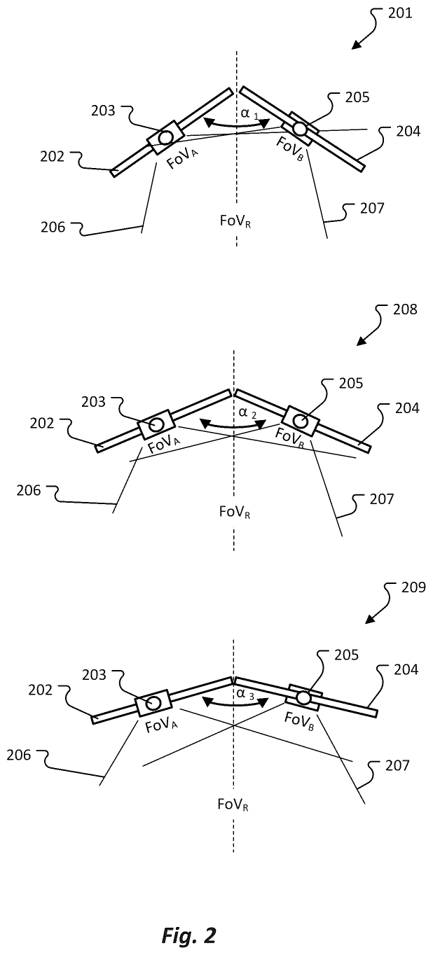

FIG. 2 depicts example display configurations that may be utilized during an enrollment process and or encountered during use of a dual screen mobile computing device. In examples, an enrollment process provides a process for obtaining user-specific calibration information that estimates an angle, or offset, between the predicted gaze locations and the actual locations of a user. That is, when an image is obtained via one or more image sensors, or cameras, the information in the image generally corresponds to an optical axis of the image sensor, or camera, and not the visual axis, or gaze, of the user. The angle difference between the optical axis and the visual axis, referred to as the Kappa angle, varies from person to person, generally varying plus or minus five degrees. The variation in the Kappa angle makes it difficult for neural networks to generalize well.

Accordingly, during a calibration process, the offset between the predicted gaze locations and the actual gaze locations can be calculated. Having multiple image sensors providing image information during the calibration process allows the system to extract more samples of the user's appearance. Further, having the hinge angle known between the two image sensors, or cameras, allows for the creation of a geometric model of the eyes such that a view direction of the user can be estimated. This information, along with the data from multiple sensors such as but no limited to left and right eye-images, facial landmarks, head pose, and other signals can be provided to a neural network to obtain an estimate of a location where a person is looking at on one of the displays or screens. Once the gaze estimates are obtained, there can exist another process for either finetuning the existing neural network to better fit the user, or a separate network or function can be used to do the finetuning.

As an initial example, a first display configuration 201 may include a first display 202 having a first camera 203 and a second display 204 having a second camera 205. A hinge angle α₁ between the first display 202 and the second display 204 may be obtained. For example, a hinge sensor or a hinge angle sensor may provide a hinge angle corresponding to an angle between each camera associated with a respective display (or each display associated with a respective camera).

Each camera 203 and 205 may include a respective field of view 206/207. Accordingly, an image of a subject within the field of views 206 and 207 may be obtained by the first camera 203 and the second camera 205. Such images, together with the hinge angle, may be utilized to generate a predicted eye gaze of the subject and or predicted head pose of the subject. For example, the angle difference between the optical axis and the visual axis, referred to as the Kappa angle can be calculated and utilized to fine tune a predicted eye gaze of the user and/or a predicted head pose of the user. Having the hinge angle known between the two image sensors, or cameras, allows for the creation of the geometric model of the eyes such that a view direction of the user can be estimated. This information, along with the data from multiple sensors such as but no limited to left and right eye-images, facial landmarks, head pose, and other signals can be provided to neural network to obtain an estimate of a location where a person is looking at on one of the displays or screens.

A second display configuration 208 may include the first display 202 and the second display 204 having a greater hinge angle than the first display configuration 201. That is, a hinge angle α₂ may be greater than the hinge angle α₁. Accordingly, a resulting field of view (e.g., FoV_{R}) for the second display configuration 208 may be greater than the resulting field of view (e.g., FoV_{R}) for the first display configuration 201. As another example, a third display configuration 209 may include the first display 202 and the second display 204 having a greater hinge angle than the first display configuration 201 and the second display configuration 208. That is, a hinge angle α₃ may be greater than the hinge angle α₁ and hinge angle α₁. Accordingly, a resulting field of view (e.g., FoV_{R}) for the third display configuration 209 may be greater than the resulting field of view (e.g., FoV_{R}) for the first display configuration 201 and the resulting field of view (e.g., FoV_{R}) for the second display configuration 208. Each display configuration 201, 208, and/or 209 may acquire images of a user from different angles.

In some examples, the sequence of display configurations 201, 208, and/or 209 may be encountered during an enrollment process where one or more targets are displayed on each of the displays 202 and/or 204 such that images of the user, the hinge angle between each display, and the location on the display corresponding to the displayed target may be obtained or recorded. For example, during the enrollment process, one or more display targets may be displayed on the display 202 and/or 204 in the first configuration 201. An image from each image sensor or camera 203 and 205 may be obtained of the user, together with the hinge angle α₁ and the location of the displayed target. Further, one or more display targets may be displayed on the display 202 and/or 204 in the first configuration 208 such that an image from each image sensor or camera 203 and 205 may be obtained of the user, together with the hinge angle α₂ and the location of the displayed target. Based on the image from each image sensor or camera 203 and 205, the neural network receives as input one or more set of landmarks, eye images and head pose one set for each of the image sensors. In some examples, when a user is utilizing the dual screen mobile computing device, a confidence level of a predicted eye gaze and/or head pose of the user may be generated based on similarity between the hinge angle and the hinge angle of one of the display configurations utilized during the enrollment process.

As another example, one or more calibration parameters may be utilized and/or obtained during an eye gaze prediction and/or head pose prediction process based on the display configuration closest to or most similar to the display configuration utilized during the enrollment process. For example, a display configuration, such as the display configuration 208 having a hinge angle α₂ may utilize different calibration and or configuration parameters than a display configuration more similar to configuration 201 having a hinge angle α₁. Thus, one or more calibration parameters closest to a display configuration, as determined by the hinge angle for example, may be used to obtain a predicted eye gaze and/or head pose having greater accuracy. Further, the offset between the predicted gaze locations and the actual gaze locations can be included as one of the calibration parameters. That is, having multiple image sensors providing image information during the calibration process allows the system to extract more samples of the user's appearance. Thus, the creation of a geometric model of the eyes allows the view direction of the user can be estimated. This information, along with the data from multiple sensors such as but no limited to left and right eye-images, facial landmarks, head pose, and other signals can be provided to a neural network to obtain an estimate of a location where a person is looking at on one of the displays or screens. Once the gaze estimates are obtained, there can exist another process for either finetuning the existing neural network to better fit the user, or a separate network or function can be used to do the finetuning.

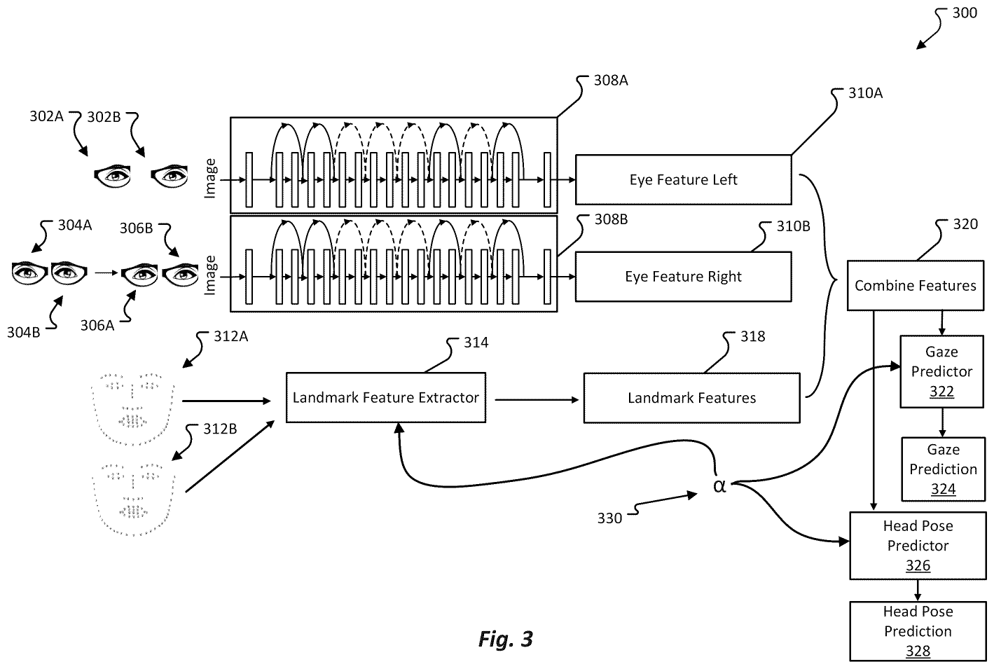

FIG. 3 depicts an example of a block diagram 300 for obtaining a predicted eye gaze and/or predicted head pose of a user in accordance with examples of the present disclosure. An image 302A of a first eye, such as the left eye of a user may be acquired or otherwise identified from an image provided from a first camera. An image 302B of the first eye, such as the left eye of the user may be acquired or otherwise identified from an image provided from a second camera. An image 304A of a second eye, such as the right eye of a user may be acquired or otherwise identified from the same image utilized to acquire or obtain the image 302A of the first eye. An image 304B of the second eye, such as the right eye of the user may be acquired or otherwise identified from the same image utilized to acquire or obtain the image 302B of the first eye. The images 302A and 302B may be provided to a neural network processing pipeline 308A to extract eye features 310A corresponding to the first eye (e.g., left eye). In examples, the neural network processing pipeline 308A may include a plurality of convolutional layers of differing size between one or more pooling layers and one or more fully connected layers. The images 304A and 304B may be provided to a neural network processing pipeline 308B to extract eye features 310B corresponding to the second eye (e.g., right eye). In examples, the neural network processing pipeline 308B may include a plurality of convolutional layers of differing size between one or more pooling layers and one or more fully connected layers. In some examples, the neural network processing pipeline 308A may eb the same as the neural network processing pipeline 308B. Accordingly, a flipped image, such as images 306A and 306B, may be utilized when the neural network processing pipelines 308A and 308B are the same.

The eye features 310A and 310B may be combined (e.g., concatenated) at 320 with other features, such as facial landmark features 318 obtained from a landmark feature extractor 314, where the combined features may be provided to an eye gaze predictor 322 to generate an eye gaze prediction 324. Similarly, the eye features 310A and 310B may be combined (e.g., concatenated) at 320 with other features, such as facial landmark features 318 obtained from the landmark feature extractor 314, where the combined features may be provided to a head pose predictor 326 to generate a head pose prediction 328. The landmark feature extractor 314 may extract facial landmark features 318 from one or more images of the user. For example, the landmark feature extractor 314 may receive a facial image 312A of a user from the same image utilized to acquire or obtain the image 302A of the first eye and the image 304A of the second eye. Alternatively, or in addition, the landmark feature extractor 314 may receive a facial image 312B of a user from the same image utilized to acquire or obtain the image 302B of the first eye and the image 304B of the second eye. The landmark feature extractor 314 may include a neural network that includes one or more flattening layers and one or more fully connected layers. In examples, the landmark feature extractor 314 may determine and/or detect the user's face and extract the facial landmark features 318, which may include but are not limited to the location of the eyes, pupils, nose, chin, ears, etc. of the user. In some examples, the hinge angle α 330 between first and second displays and/or first and second cameras may be provided to the gaze predictor 322, head pose predictor 326, and/or landmark feature extractor 314 for use in generating the eye gaze prediction 324 and/or head pose prediction 328. The eye gaze predictor 322 and/or the head pose predictor 326 may include, but is not limited to, a transformer model, convolution neural network model, and/or a support vector machine model. In examples, the offset between the predicted gaze locations and the actual gaze locations can be calculated. This information, along with the data from multiple sensors such as but no limited to left and right eye-images, facial landmarks, head pose, and other signals can be provided to a neural network to obtain an estimate of a location where a person is looking at on one of the displays or screens. Once the gaze estimates are obtained, there can exist another process for either finetuning the existing neural network to better fit the user, or a separate network or function can be used to do the finetuning.

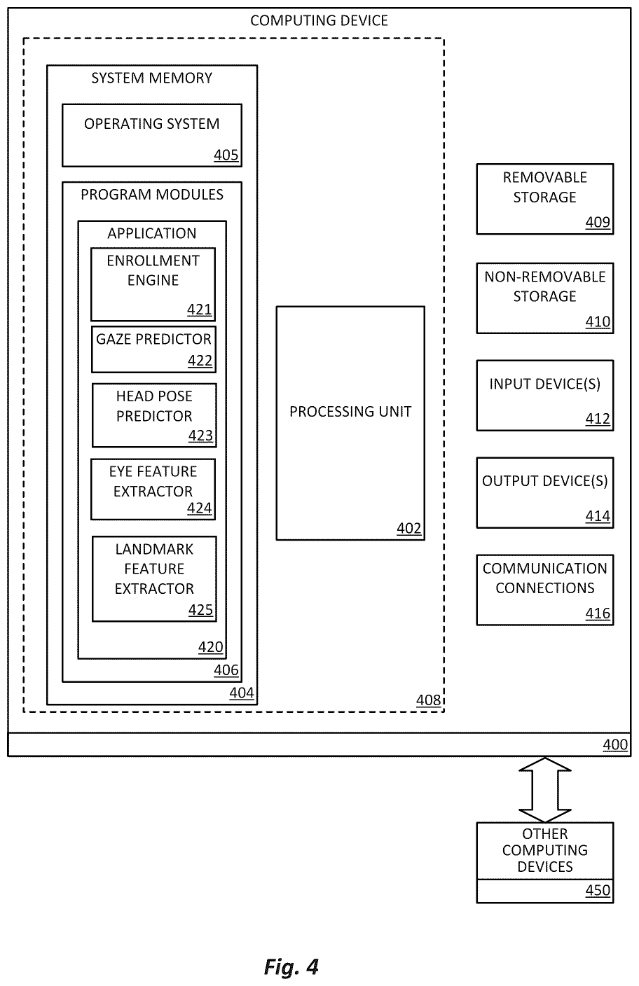

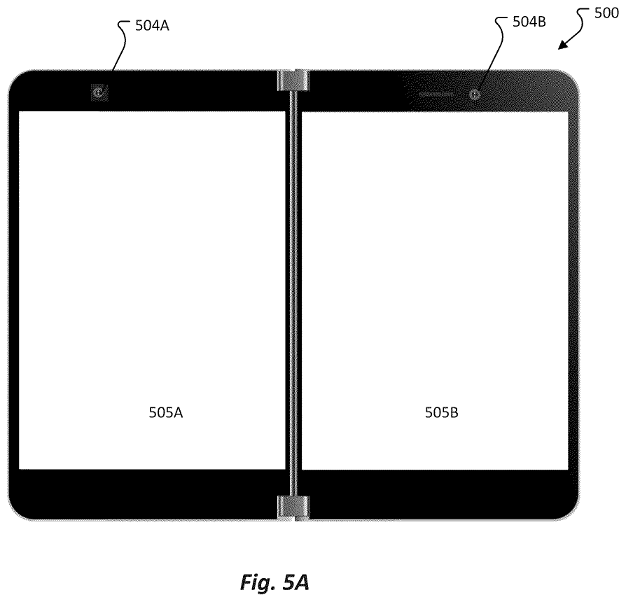

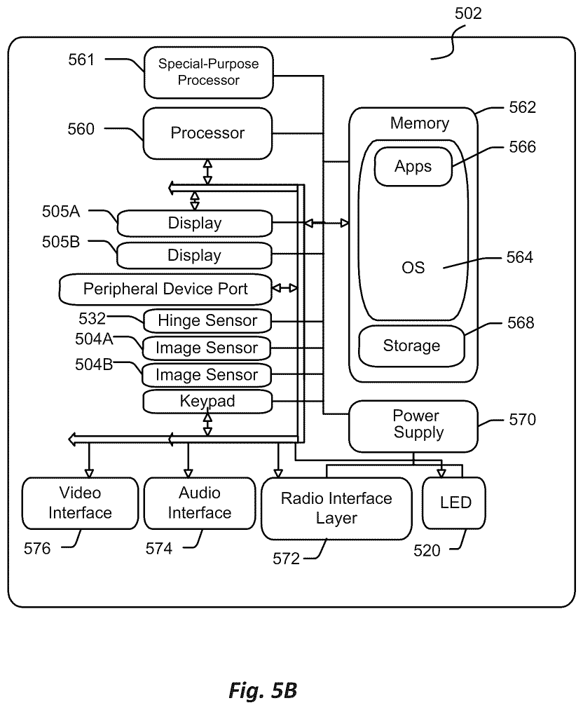

FIGS. 4-5B and the associated descriptions provide a discussion of a variety of operating environments in which aspects of the disclosure may be practiced. However, the devices and systems illustrated and discussed with respect to FIGS. 4-5B are for purposes of example and illustration and are not limiting of a vast number of computing device configurations that may be utilized for practicing aspects of the disclosure, described herein.

FIG. 4 is a block diagram illustrating physical components (e.g., hardware) of a computing device 400 with which aspects of the disclosure may be practiced. The computing device components described below may be suitable for the computing and/or processing devices described above. In a basic configuration, the computing device 400 may include at least one processing unit 402 and a system memory 404. Depending on the configuration and type of computing device, the system memory 404 may comprise, but is not limited to, volatile storage (e.g., random-access memory (RAM)), non-volatile storage (e.g., read-only memory (ROM)), flash memory, or any combination of such memories.

The system memory 404 may include an operating system 405 and one or more program modules 406 suitable for running software application 420, such as one or more components supported by the systems described herein. As examples, system memory 404 may include an enrollment engine 421, the gaze predictor 422, the head pose predictor 423, an eye feature extractor 424, and the landmark feature extractor 425. The enrollment engine may perform one or more processes for capturing and associating a hinge angle with a displayed target location, predicted eye gaze, and/or predicted head gaze of a user as previously described and as further described herein. The gaze predictor 422 may be the same as or similar to the gaze predictor 322 previously described. The head pose predictor 423 may be the same as or similar to the head pose predictor 326 as previously described. The eye feature extractor 424 may be the same as or similar to the neural network processing pipeline 308 as previously described. The landmark feature extractor 425 may be the same as or similar to the landmark feature extractor 314 as previously described. The operating system 405, for example, may be suitable for controlling the operation of the computing device 400.

Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 (e.g., applications 420) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided programs, etc.

Furthermore, embodiments of the disclosure may be practiced in an electrical circuit discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality, all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

The computing device 400 may also have one or more input device(s) 412 such as a keyboard, a mouse, a pen, a sound or voice input device, a touch or swipe input device, etc. The one or more input device 412 may include a plurality of image sensors, such as the image sensor 103A and/or 103B. Further, the one or more input devices 412 may include a hinge angle sensor that provides a hinge angle between one or more display devices. The output device(s) 414 such as a plurality of displays, speakers, a printer, etc. may also be included. The aforementioned devices are examples and others may be used. The computing device 400 may include one or more communication connections 416 allowing communications with other computing devices 450. Examples of suitable communication connections 416 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable, and non-removable media implemented in any method or technology for storage of information, such as computer readable instructions, data structures, or program modules. The system memory 404, the removable storage device 409, and the non-removable storage device 410 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 5A-5B illustrate a mobile computing device 500, for example, a mobile telephone, a smart phone, wearable computer (such as a smart watch), a tablet computer, a laptop computer, and the like, with which embodiments of the disclosure may be practiced. In some respects, the client may be a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes displays 505A and 505B and one or more buttons or areas that allow the user to enter information into the mobile computing device 500. The displays 505A and/or 505B of the mobile computing device 500 may also function as an input device (e.g., a touch screen display).

In yet another alternative embodiment, the mobile computing device 500 is a portable phone system, such as a cellular phone. The mobile computing device 500 may also include an optional keypad. Optional keypad may be a physical keypad or a “soft” keypad generated on the touch screen display 505A/505B.

In various embodiments, the output elements include the displays 505A and 505B for showing a graphical user interface (GUI), a visual indicator (e.g., a light emitting diode), and/or an audio transducer (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile computing device. That is, the mobile computing device 500 can incorporate a system (e.g., an architecture) 502 to implement some aspects. In one embodiment, the system 502 is implemented as a “smart phone” capable of running one or more applications (e.g., browser, e-mail, calendaring, contact managers, messaging clients, games, and media clients/players). In some aspects, the system 502 is integrated as a computing device, such as an integrated personal digital assistant (PDA) and wireless phone.

One or more application programs 566 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, maps programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500 described herein (e.g., search engine, extractor module, relevancy ranking module, answer scoring module, etc.).

The system 502 has a power supply 570, which may be implemented as one or more batteries. The power supply 570 might further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the operating system 564, and vice versa.

The visual indicator 520 may be used to provide visual notifications, and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and/or special-purpose processor 561 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone may also serve as an audio sensor to facilitate control of notifications, as will be described below. The system 502 may further include a video interface 576 that enables an operation of an on-board cameras or images sensors 504A and 504B to acquire still images, video streams, and the like. The n-board cameras or images sensors 504A and 504B may be the same as or similar to the previously described image sensors 103A and/or 103B. in some examples, the system 502 may include a hinge sensor 532 for obtaining the hinge angle between a first display, such as display 505A and/or the second display, such as display 505B. In some examples, the hinge sensor 532 may obtain a hinge angle between the first image sensor 504A and the second image sensor 504B.

In some examples, the special-purpose processor 561 may correspond to a neural processing engine (e.g., NPE) or neural processing unit (NPU).

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data/information may be readily transferred between computing devices for storage and use according to well-known data/information transfer and storage means, including electronic mail and collaborative data/information sharing systems.

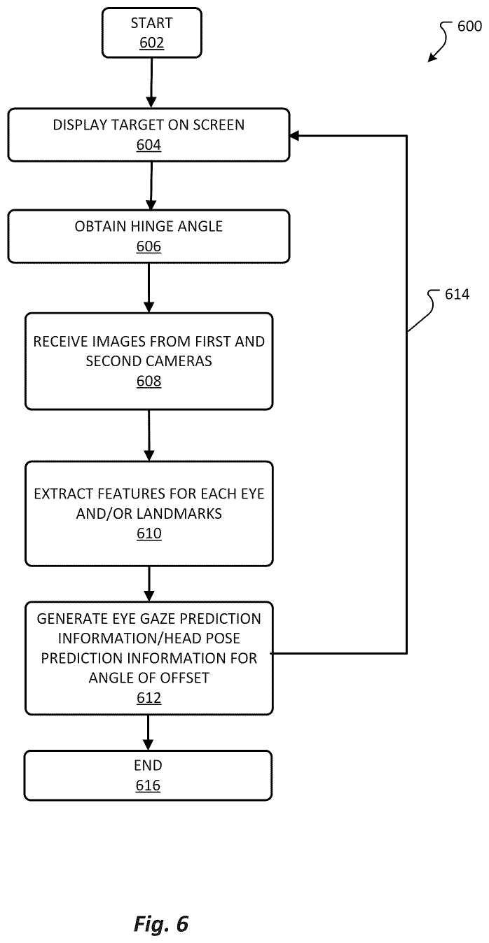

FIG. 6 depicts details of a method 600 for obtaining calibration information, including Kappa, at different hinge angles for the generation of eye gaze prediction information and/or head pose prediction information in accordance with examples of the present disclosure. Having multiple sensors during calibration provides more samples of the user's appearance. Obtaining the hinge angle between the two cameras allows for the creation of a geometric model of the eyes from which a view direction can be estimated. This information along with the data from multiple sensors such as eye-images (left and right), facial landmarks, and/or head pose can be fed into a neural network to obtain an estimate of where a user is looking at a screen.

A general order for the steps of the method 600 is shown in FIG. 6. Generally, the method 600 starts at 602 and ends at 616. The method 600 may include more or fewer steps or may arrange the order of the steps differently than those shown in FIG. 6. The method 600 can be executed as a set of computer-executable instructions executed by a computer system and encoded or stored on a computer readable medium. In examples, aspects of the method 600 are performed by one or more processing devices, such as a computer or server. Further, the method 600 can be performed by gates or circuits associated with a processor, Application Specific Integrated Circuit (ASIC), a field programmable gate array (FPGA), a system on chip (SOC), a neural processing unit, or other hardware device. Hereinafter, the method 600 shall be explained with reference to the systems, components, modules, software, data structures, user interfaces, etc. described in conjunction with FIGS. 1-5.

The method starts at 602, where flow may proceed to 604. At 604, a target may be displayed on a first screen of the dual screen computing device. The method 600 may proceed to 606, where a hinge angle is obtained. In examples, the hinge angle may be obtained at 606 from a hinge sensor, for example the hinge sensor 532, or otherwise may be calculated, utilizing images received from each of the image sensors. The method 600 may proceed to 608, where an image may be received from a first camera or first image sensor and an image may be received from a second camera or a second image sensor.

In examples, a method 600 may proceed to 610 where a plurality of features may be extracted or otherwise obtained from the received images. For example, for a first eye, images of the first eye from the first and second cameras may be provided to the neural network processing pipeline, such as the neural network processing pipeline 308, where the neural network processing pipeline 308 may extract eye features for the first eye. For a second eye, images of the second eye from the first and second cameras may be provided to the neural network processing pipeline, such as the neural network processing pipeline 308, where the neural network processing pipeline 308 may extract eye features for the second eye. In examples, facial images of the user from the first and second cameras may be provided to the landmark feature extractor, such as the landmark feature extractor 314, where the landmark feature extractor 314 may extract landmark features for the user's face.

The method may proceed to 612 where eye gaze prediction information and/or head pose prediction information may be generated, where such information may be specific to the hinge angle and the target displayed on the screen. In examples, one or more calibration parameters may be obtained or otherwise generated for the hinge angle and/or target displayed on the screen. Such information may be stored together and later accessed based on an acquired hinge angle. As one example, an angle of offset, Kappa, may be estimated for each user and stored, wherein the Kappa angle may be associated with a hinge angle. In some examples, the Kappa angle may be provided or accessed via a user identifier. In some examples, for a single hinge angle, a plurality of display targets may be sequentially displayed on the screen. Thus, the method 600 may proceed through 606, 608, 610, and 612 multiple times for a single hinge angle, as indicated by 614. In addition, as a user is instructed to change the hinge angle, the method 600 may proceed through 606, 608, 610, and 612 multiple times as indicated by 614. The method 600 may end at 616.

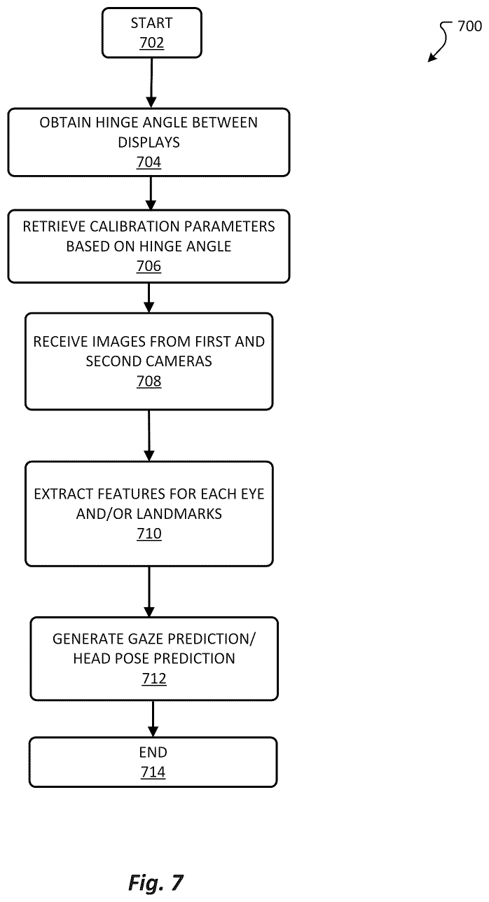

FIG. 7 depicts details of a method 700 for generating an eye gaze prediction and/or a head pose prediction utilizing a hinge angle between displays of a dual screen computing device in accordance with examples of the present disclosure. A general order for the steps of the method 700 is shown in FIG. 7. Generally, the method 700 starts at 702 and ends at 714. The method 700 may include more or fewer steps or may arrange the order of the steps differently than those shown in FIG. 7. The method 700 can be executed as a set of computer-executable instructions executed by a computer system and encoded or stored on a computer readable medium. In examples, aspects of the method 700 are performed by one or more processing devices, such as a computer or server. Further, the method 700 can be performed by gates or circuits associated with a processor, Application Specific Integrated Circuit (ASIC), a field programmable gate array (FPGA), a system on chip (SOC), a neural processing unit, or other hardware device. Hereinafter, the method 700 shall be explained with reference to the systems, components, modules, software, data structures, user interfaces, etc. described in conjunction with FIGS. 1-6.

The method starts at 702, where flow may proceed to 704. At 704, a hinge angle may be obtained from each display of a dual screen computing device. In examples, the hinge angle may be obtained from a hinge sensor, for example the hinge sensor 532, or otherwise may be calculated, utilizing images received from each of the image sensors. The method 700 may proceed to 706, where one or more calibration parameters may be retrieved based on the angel of offset. In one or more examples, an angle of offset, such as the Kappa angle, may be obtained as one or more calibration parameters. In some examples, the one or more calibration parameters may correspond to a confidence level and/or may be utilized for different display configurations. For example, a display configuration where the hinge angle is less than thirty degrees for example, may utilize different calibration parameters than when the hinge angle is greater than sixty degrees. The method 700 may proceed to 708, where an image may be received from a first camera or first image sensor and an image may be received from a second camera or a second image sensor.

In examples, the method 700 may proceed to 710 where a plurality of features may be extracted or otherwise obtained from the received images. For example, for a first eye, images of the first eye from the first and second cameras may be provided to the neural network processing pipeline, such as the neural network processing pipeline 308, where the neural network processing pipeline 308 may extract eye features for the first eye. For a second eye, images of the second eye from the first and second cameras may be provided to the neural network processing pipeline, such as the neural network processing pipeline 308, where the neural network processing pipeline 308 may extract eye features for the second eye. In examples, facial images of the user from the first and second cameras may be provided to the landmark feature extractor, such as the landmark feature extractor 314, where the landmark feature extractor 314 may extract landmark features for the user's face.

The method may proceed to 712 where eye gaze prediction information and/or head pose prediction information may be generated, where such information may be specific to the hinge angle obtained at 704 and/or the Kappa angle obtained at 704. In examples, the hinge angle and/or Kappa angle may be utilized to generate the eye gaze prediction information and/or the head pose prediction information. Alternatively, or in addition, the hinge angle may be utilized to provide a confidence level, where the confidence level may be based on a hinge angle utilized in the enrolment process and the hinge angle obtained at 704. The method 700 may end at 714.

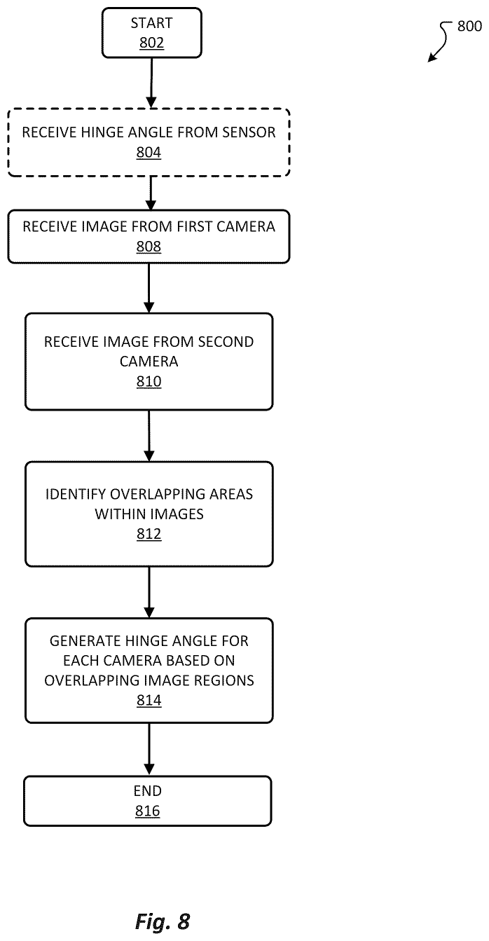

FIG. 8 depicts details of a method 800 for obtaining a hinge angle between one or more displays of a dual screen computing device in accordance with examples of the present disclosure. A general order for the steps of the method 800 is shown in FIG. 8. Generally, the method 800 starts at 802 and ends at 816. The method 800 may include more or fewer steps or may arrange the order of the steps differently than those shown in FIG. 8. The method 800 can be executed as a set of computer-executable instructions executed by a computer system and encoded or stored on a computer readable medium. In examples, aspects of the method 800 are performed by one or more processing devices, such as a computer or server. Further, the method 800 can be performed by gates or circuits associated with a processor, Application Specific Integrated Circuit (ASIC), a field programmable gate array (FPGA), a system on chip (SOC), a neural processing unit, or other hardware device. Hereinafter, the method 800 shall be explained with reference to the systems, components, modules, software, data structures, user interfaces, etc. described in conjunction with FIGS. 1-7.

The method starts at 802, where flow may proceed to 804. At 804, an angle may be obtained directly from a hinge sensor as previously discussed. Alternatively, or in addition, an image from a first camera may be obtained at 808 and an image from a second camera may be obtained at 810. In examples, overlapping regions or overlapping areas within such images may be identified at 812, such that an angle for each camera with respect to the other camera may be determined or otherwise generated at 814 based on such overlapping image regions. That is, where a hinge sensor may not be present to provide a direct measurement of a hinge angle between a first display and a second display, the method 800 may generate such angle for use in the calibration and/or enrollment process, and/or for use when generating the eye gaze prediction information and/or the head pose prediction information. The method 800 may end at 816.

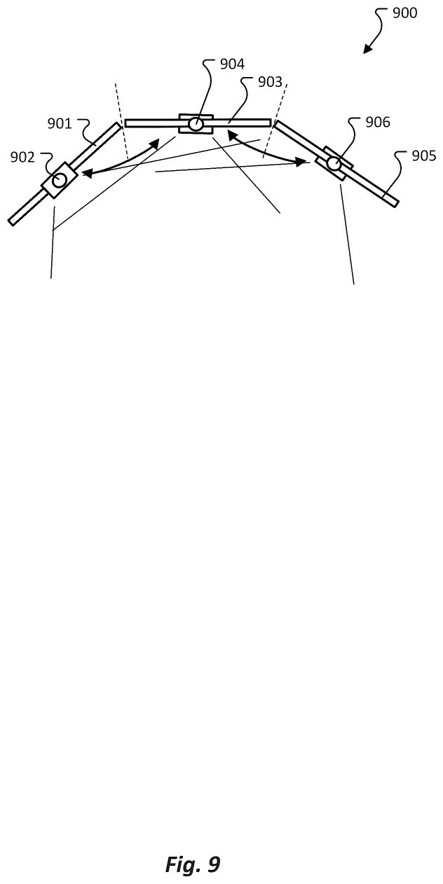

FIG. 9 depicts an example of a display configuration 900 in accordance with examples of the present disclosure. As previously discussed, two or more displays or screens may be utilized, to obtain a predicted eye gaze and/or a predicted head pose of a subject or a user. As depicted in FIG. 9, a display device configuration may include a first display 901 having a first camera 902, a second display 903 having a second camera 904, and third display 905 having a third camera 906. As previously discussed, angles of offsets between each display and/or camera may be obtained and/or generated utilizing a hinge sensor or utilizing a method 800 for example. Such additional images obtained from the display configuration of FIG. 9 may provide a predicted eye gaze and/or predicted head pose of a user of increased accuracy.

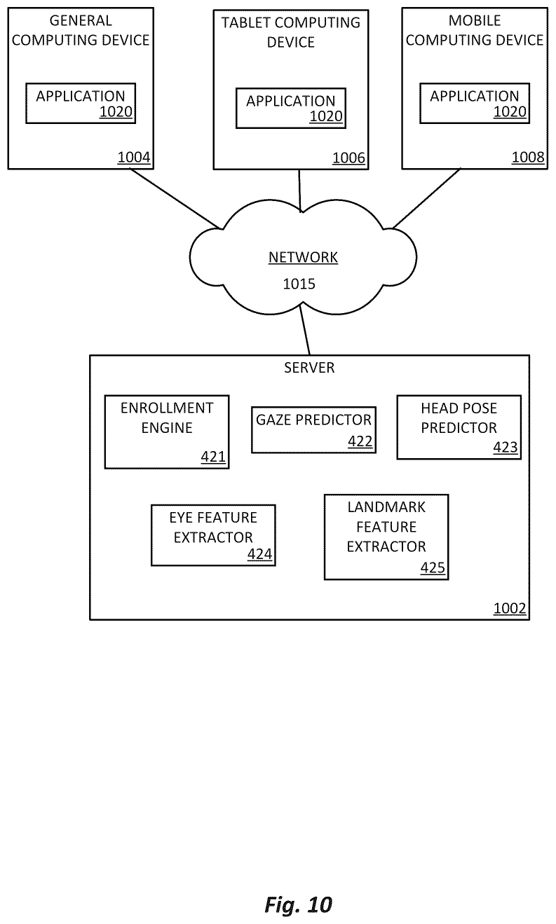

FIG. 10 illustrates one aspect of the architecture of a system for processing data received at a computing system from a remote source, such as a personal computer 1004, tablet computing device 1006, or mobile computing device 1008, as described above. The personal computer 1004, tablet computing device 1006, or mobile computing device 1008 may include the gaze eye gaze predictor and/or head pose predictor as previously described. Content at a server device 1002 may be stored in different communication channels or other storage types. For example, various documents may be stored using a directory service, a web portal, a mailbox service, an instant messaging store, or social networking services.

One or more of the previously described program modules 406 or software applications 420 may be employed by server device 1002 and/or the personal computer 1004, tablet computing device 1006, or mobile computing device 1008, as described above. For example, the server device 1002 may include the enrollment engine 421, the gaze predictor 422, the head pose predictor 423, the eye feature extractor 424, and the landmark feature extractor 425.

The server device 1002 may provide data to and from a client computing device such as a personal computer 1004, a tablet computing device 1006 and/or a mobile computing device 1008 (e.g., a smart phone) through a network 1015. By way of example, the computer system described above may be embodied in a personal computer 1004, a tablet computing device 1006 and/or a mobile computing device 1008 (e.g., a smart phone). Any of these embodiments of the computing devices may obtain content from the store, in addition to receiving graphical data useable to be either pre-processed at a graphic-originating system, or post-processed at a receiving computing system.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application.

The present disclosure relates to systems and methods for generating a predicted eye gaze of a user according to at least the examples provided in the sections below:
(A1) In accordance with at least one aspect of the present disclosure, a method for generating a predicted eye gaze of a user is disclosed. The method may include receiving a first image of a user from a first camera; receiving a second image of the user from a second camera; obtaining a hinge angle between the first camera and the second camera; extracting feature information for a first eye of the user based on the first image and the second image; extracting feature information for a second eye of the user based on the first image and the second image; extracting facial landmark features for the user based on at least one of the first image and the second image; and generating, using an eye gaze predictor, a predicted eye gaze for the user based on the extracted feature information for the first eye of the user, the extracted feature information for the second eye of the user, and the extracted facial landmark features, wherein a confidence level associated with the predicted eye gaze for the user is based on the obtained hinge angle.
(A2) In accordance with at least one aspect of A1 above, the hinge angle is obtained from a hinge sensor for a hinge joining a first display associated with the first camera and a second display associated with the second camera.
(A3) In accordance with at least one aspect of A1-A2 above, the hinge angle is generated from the first image and the second image.
(A4) In accordance with at least one aspect of A1-A3 above, the method further includes retrieving one or more calibration parameters utilizing the hinge angle; and generating the predicted eye gaze for the user utilizing the retrieved one or more calibration parameters.
(A5) In accordance with at least one aspect of A1-A4 above, the method further includes performing a user enrollment process that includes for each of a plurality of hinge angles: displaying a target at a display device; receiving an image of the user from the first camera; receiving an image of the user from the second camera; extracting feature information for the first eye of the user based on the image of the user from the first camera and the image of the user from the second camera; extracting feature information for the second eye of the user based on the image of the user from the first camera and the image of the user from the second camera; extracting facial landmark features for the user based on at least one of the images of the user from the first camera and the second camera; generating, using the eye gaze predictor, an angle of offset between an optical axis of one or more of the first camera and second camera, and visual axis associated with the user, wherein the angle of offset is based on the hinge angle, the extracted feature information for the first eye of the user, the extracted feature information for the second eye of the user, and the extracted facial landmark features; and storing the angle of offset in association with a user identifier.
(A6) In accordance with at least one aspect of A1-A5 above, the method further includes generating, using a head pose predictor, a predicted head pose for the user based on the extracted feature information for the first eye of the user, the extracted feature information for the second eye of the user, and the extracted facial landmark features, wherein a confidence level associated with the predicted head pose for the user is based on the obtained hinge angle; and associating and storing the predicted head pose for the user with the hinge angle.
(A7) In accordance with at least one aspect of A1-A6 above, the predicted eye gaze of the user is generated for a mobile computing device having two or more displays.
(A8) In accordance with at least one aspect of A1-A7 above, the method further includes generating, using a head pose predictor, a predicted head pose for the user based on the extracted feature information for the first eye of the user, the extracted feature information for the second eye of the user, and the extracted facial landmark features, wherein a confidence level associated with the predicted head pose for the user is based on the obtained hinge angle.
(A9) In accordance with at least one aspect of A1-A8 above, extracting feature information for the second eye of the user is based on a flipped version of the first image and a flipped version of the second image.
(A10) In accordance with at least one aspect of A1-A9 above, the extracted feature information for the first eye of the user is obtained using a neural network trained to extract eye features from images.

In yet another aspect, some examples include a system including one or more processors and memory coupled to the one or more processors, the memory storing one or more instructions which when executed by the one or more processors, causes the one or more processors perform any of the methods described herein (e.g., A1-A10 described above).

In yet another aspect, some examples include a non-transitory computer-readable storage medium storing one or more programs for execution by one or more processors of a storage device, the one or more programs including instructions for performing any of the methods described herein (e.g., A1-A10 described above).
(B1) In accordance with at least one aspect of the present disclosure, a method for generating a predicted eye gaze of a user is disclosed. The method may include receiving a first image of a user from a first image sensor; receiving a second image of the user from a second image sensor; obtaining a hinge angle between a first display associated with the first image sensor and a second display associated with the second image sensor; extracting feature information for a first eye of the user based on the first image and the second image; extracting feature information for a second eye of the user based on the first image and the second image; extracting facial landmark features for the user based on at least one of the first image and the second image; generating an estimated eye gaze for the user based on the extracted feature information for the first eye of the user, the extracted feature information for the second eye of the user, and the extracted facial landmark features; calculating a first angle of offset between an optical axis of the first image sensor and a visual axis of the user; calculating a second angle of offset between an optical axis of the second image sensor and the visual axis of the user; and generating at least one of a predicted eye gaze for the user or a predicted head pose for the user based on extracted feature information for the first eye of the user, extracted feature information for the second eye of the user, extracted facial landmark features, and at least one of the first and second angle of offsets.
(B2) In accordance with at least one aspect of B1 above, the hinge angle is obtained from a hinge sensor for a hinge joining a first display associated with the first image sensor and a second display associated with the second image sensor.
(B3) In accordance with at least one aspect of B1-B2 above, the hinge angle is generated from the first image and the second image.
(B4) In accordance with at least one aspect of B1-B3 above, the method further includes retrieving one or more calibration parameters utilizing the hinge angle; and generating the predicted eye gaze for the user utilizing the retrieved one or more calibration parameters.
(B5) In accordance with at least one aspect of B1-B4 above, the method further includes performing a user enrollment process that includes for each of a plurality of hinge angles: displaying a target at a display device; receiving an image of the user from the first image sensor; receiving an image of the user from the second image sensor; extracting feature information for the first eye of the user based on the image of the user from the first image sensor and the image of the user from the second image sensor; extracting feature information for the second eye of the user based on the image of the user from the first image sensor and the image of the user from the second image sensor; extracting facial landmark features for the user based on at least one of the images of the user from the first image sensor and the second image sensor; generating, using an angle of offset between an optical axis of one or more of the first image sensor and second image sensor, and visual axis associated with the user, wherein the angle of offset is based on the hinge angle, the extracted feature information for the first eye of the user, the extracted feature information for the second eye of the user, and the extracted facial landmark features; and storing the angle of offset in association with a user identifier.

In yet another aspect, some examples include a system including one or more processors and memory coupled to the one or more processors, the memory storing one or more instructions which when executed by the one or more processors, causes the one or more processors perform any of the methods described herein (e.g., B1-B5 described above).

In yet another aspect, some examples include a non-transitory computer-readable storage medium storing one or more programs for execution by one or more processors of a storage device, the one or more programs including instructions for performing any of the methods described herein (e.g., B1-B5 described above).

Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method for generating a predicted eye gaze of a user, the method comprising:
receiving a first image of a user from a first camera;
receiving a second image of the user from a second camera;
obtaining a hinge angle between the first camera and the second camera;
extracting feature information for a first eye of the user based on the first image and the second image;
extracting feature information for a second eye of the user based on the first image and the second image;
extracting facial landmark features for the user based on at least one of the first image and the second image; and
generating, using an eye gaze predictor, a predicted eye gaze for the user based on the extracted feature information for the first eye of the user, the extracted feature information for the second eye of the user, and the extracted facial landmark features, wherein a confidence level associated with the predicted eye gaze for the user is based on the obtained hinge angle.

2. The method of claim 1, wherein the hinge angle is obtained from a hinge sensor for a hinge joining a first display associated with the first camera and a second display associated with the second camera.

3. The method of claim 1, wherein the hinge angle is generated from the first image and the second image.

4. The method of claim 1, further comprising:
retrieving one or more calibration parameters utilizing the hinge angle; and
generating the predicted eye gaze for the user utilizing the retrieved one or more calibration parameters.

5. The method of claim 4, further comprising performing a user enrollment process that includes for each of a plurality of hinge angles:
displaying a target at a display device;
receiving an image of the user from the first camera;
receiving an image of the user from the second camera;
extracting feature information for the first eye of the user based on the image of the user from the first camera and the image of the user from the second camera;
extracting feature information for the second eye of the user based on the image of the user from the first camera and the image of the user from the second camera;
extracting facial landmark features for the user based on at least one of the images of the user from the first camera and the second camera;
generating, using the eye gaze predictor, an angle of offset between an optical axis of one or more of the first camera and second camera, and visual axis associated with the user, wherein the angle of offset is based on the hinge angle, the extracted feature information for the first eye of the user, the extracted feature information for the second eye of the user, and the extracted facial landmark features; and
storing the angle of offset in association with a user identifier.

6. The method of claim 5, further comprising:
generating, using a head pose predictor, a predicted head pose for the user based on the extracted feature information for the first eye of the user, the extracted feature information for the second eye of the user, and the extracted facial landmark features, wherein a confidence level associated with the predicted head pose for the user is based on the obtained hinge angle; and
associating and storing the predicted head pose for the user with the hinge angle.

7. The method of claim 1, wherein the predicted eye gaze of the user is generated for a mobile computing device having two or more displays.

8. The method of claim 1, further comprising:
generating, using a head pose predictor, a predicted head pose for the user based on the extracted feature information for the first eye of the user, the extracted feature information for the second eye of the user, and the extracted facial landmark features, wherein a confidence level associated with the predicted head pose for the user is based on the obtained hinge angle.

9. The method of claim 1, wherein extracting feature information for the second eye of the user is based on a flipped version of the first image and a flipped version of the second image.

10. The method of claim 1, wherein the extracted feature information for the first eye of the user is obtained using a neural network trained to extract eye features from images.

11. A system for generating at least one of a predicted eye gaze or a predicted head pose of a user, the system comprising:
a processor;
a first image sensor;
a second image sensor; and
memory including instructions, which when executed by the processor, cause the processor to:
receive a first image of a user from the first image sensor;
receive a second image of the user from the second image sensor;
obtain a hinge angle between a first display associated with the first image sensor and a second display associated with the second image sensor;
extract feature information for a first eye of the user based on the first image and the second image;
extract feature information for a second eye of the user based on the first image and the second image;
extract facial landmark features for the user based on at least one of the first image and the second image;
generate an estimated eye gaze for the user based on the extracted feature information for the first eye of the user, the extracted feature information for the second eye of the user, and the extracted facial landmark features;
calculate a first angle of offset between an optical axis of the first image sensor and a visual axis of the user;
calculate a second angle of offset between an optical axis of the second image sensor and the visual axis of the user; and
generate at least one of a predicted eye gaze for the user or a predicted head pose for the user based on extracted feature information for the first eye of the user, extracted feature information for the second eye of the user, extracted facial landmark features, and at least one of the first and second angle of offsets.

12. The system of claim 11, further comprising a hinge sensor configured to measure a hinge angle between the first display and the second display.

13. The system of claim 11, wherein the hinge angle is generated from the first image and the second image.

14. The system of claim 11, wherein the instructions, when executed by the processor, cause the processor to:
retrieve one or more calibration parameters utilizing the hinge angle; and
generate the predicted eye gaze for the user utilizing the retrieved one or more calibration parameters.

15. The system of claim 11, wherein extracting feature information for the second eye of the user is based on a flipped version of the first image and a flipped version of the second image.

16. The system of claim 11, wherein a confidence level associated with the at least one of the predicted eye gaze for the user or the predicted head pose for the user is based on the obtained hinge angle.

17. A computer storage medium including instructions, which when executed by a processor, cause the processor to:
receive a first image of a user from a first image sensor;
receive a second image of the user from a second image sensor;
obtain a hinge angle between a first display associated with the first image sensor and a second display associated with the second image sensor;
extract feature information for a first eye of the user based on the first image and the second image;
extract feature information for a second eye of the user based on the first image and the second image;
extract facial landmark features for the user based on at least one of the first image and the second image; and
generate at least one of a predicted eye gaze for the user or a predicted head pose for the user based on the extracted feature information for the first eye of the user, the extracted feature information for the second eye of the user, and the extracted facial landmark features, wherein the at least one of the predicted eye gaze for the user or the predicted head pose for the user is based on an angle of offset between an optical axis of an image sensor and a visual axis of the user.

18. The computer storage medium of claim 17, wherein the hinge angle is generated from the first image and the second image.

19. The computer storage medium of claim 17, wherein extracting feature information for the second eye of the user is based on a flipped version of the first image and a flipped version of the second image.

20. The computer storage medium of claim 17, wherein the instructions, which when executed by a processor, cause the processor to:
extract feature information for the first eye of the user using a neural network trained to extract eye features from images, wherein a confidence level associated with the at least one of the predicted eye gaze for the user or the predicted head pose for the user is based on the obtained hinge angle.
